(19) United States
(12) Patent Application Publication
(10) Pub. No.: US 2010/0050246 A1
(43) Pub. Date: Feb. 25, 2010

(54) TRUSTING SECURITY ATTRIBUTE AUTHORITIES THAT ARE BOTH COOPERATIVE AND COMPETITIVE

(75) Inventors: Mary Ellen Zurko, Groton, MA (US); Joseph A. Pescatello, Rye, NH (US)

Correspondence Address: Scully, Scott, Murphy & Presser, P.C., 400 Garden City Plaza, Suite 300, Garden City, NY, 11530, US

(73) Assignee: INTERNATIONAL BUSINESS MACHINES CORPORATION, Armonk, NY (US)

(21) Appl. No.: 12/609,493

(22) Filed: Oct. 30, 2009

Related U.S. Application Data
(63) Continuation of application No. 10/334,536, filed on Dec. 31, 2002, now abandoned.

(51) Int. Cl. H04L 29/06; G06F 17/00

(52) U.S. Cl. 726/8; 726/1

(57) ABSTRACT

A method and system for authorizing a user. The method comprises the steps of assigning a first role to a user in a first domain, assigning a second role in a second domain to the first role, and assigning access to a resource in the second domain to the second role. The method comprises the further steps of receiving a request from the user for the resource; and providing access to the resource, to the user. The invention may be employed by users and services to manage their interaction with those services, including configuring which they trust for what types of information, in what applications, and which subsets of information they can be trusted to provide.

### BACKGROUND OF THE INVENTION

1. Field of the Invention

This invention generally relates to methods and systems for authorizing users with access to resources. More specifically, the invention relates to such methods and systems particularly well suited for use in distributed computer or network systems that cross domains, such as domains that may be both cooperative and competitive.

2. Background Art

In a distributed computer or network system, security authorities, such as authentication (Kerberos, public key Certificate Authorities (CA)) or authorization authorities, may be in different management domains. Authorities within a single domain can often be considered to be similarly trustworthy. For instance, all authentication authorities at a first company may be trusted to authenticate its employees. However, transactions in a distributed system often cross domains.

For example, employees from that first company may work together with employees from a second company on a joint standards proposal. Authentication authorities at the second company would be not trusted to authenticate employees of the first company, but those authorities at the second company might be trusted to provide authentication information for the applications or databases being used in the cross enterprise working group.

Thus, there is a need for security services that at times are competitive (not trusted) and at times are cooperative (trusted). Both users and services need to manage their interactions with those services, including configuring which they trust for what types of information (authentication, authorization), in what applications (Sametime, Notes), and even which subsets of information they can be trusted to provide. These configurations could keep an authentication service from mistakenly being used for an authorization service, as well as keeping an authentication service in the domain of the second company from asserting the identities of the employees of the first company.

Various procedures are known for providing role based access control and that offer limited cross-domain capabilities. One cross-domain access scheme requires that domains share the same roles. Users who belong to Role1 in DomainA are given access to resources in DomainB that are assigned to Role1 in DomainB. A limitation of this scenario, however, is that it requires all domains to share a homogenous role schema. In competitive and cooperative relationships this will rarely be the case.

A second cross-domain scheme requires that a user from DomainA must be explicitly included in a role in DomainB in order to access the associated resources in DomainB. A limitation of this approach is that DomainB must maintain a list of all users in DomainA who are given access to DomainB's resources. This poses a heavy burden on the administrators of DomainB.

A third cross-domain scheme requires that Domain B trusts Domain A for all of the attributes Domain A might provide that ate scoped by the identities they are associated with, filtered by a wildcard form of the name. Thus domain B can trust Domain A for attributes associated with names of the form “/Lotus/IBM,” but not “/Tivoli/IBM.”

### SUMMARY OF THE INVENTION

An object of this invention is to improve methods and systems for authorizing users with access to resources

Another object of the invention is to provide a method for allowing access to local resources in one domain based on an attribute such as a group or role from a second domain.

A further object of the present invention is to provide a procedure, which operates across domains, for authorizing users access to resources.

These and other objectives are attained with a method and system for authorizing a user. The method comprises the steps of assigning a first role to a user in a first domain, assigning a second role in a second domain to the first role, and assigning access to a resource in the second domain to the second role. The method comprises the further steps of receiving a request from the user for the resource; and providing access to the resource, to the user.

The present invention may also be used for mapping from an attribute (role) in one domain to an identity (user) in another domain. This method comprises the steps of assigning a role to a user in a first domain, assigning an identity in a second domain to the role, and assigning access to a resource in the second domain to the identity. The method comprises the further steps of receiving a request from the user with the role for the resource, mapping the request to the identity in the second domain, and providing access to the resource, to the user.

The invention may be employed by users and services to manage their interaction with those services, including configuring which they trust for what types of information, in what applications, and which subsets of information they can be trusted to provide. This configuration information may be specified using any aspect of the information in question, including ancillary attributes. So, for example, configuration information may state that a certain CA is only trusted to produce certificates whose key is used for encrypting, but not for signing. Richer attribute associations can produce richer rules. More flexible matching of attribute values (such as value comparisons or wildcarding) may further enhance the rule set. Also, attributes that are not trusted can be stripped out. For example, an attribute authority may be trusted to specify a certain group. All other attributes received from this authority are removed from or ignored in the request.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 depicts the operation of the present invention.

FIG. 2 shows two domains that may be used in the implementation of this invention.

### DETAILED DESCRIPTION OF THE PREFERRED EMBODIMENTS

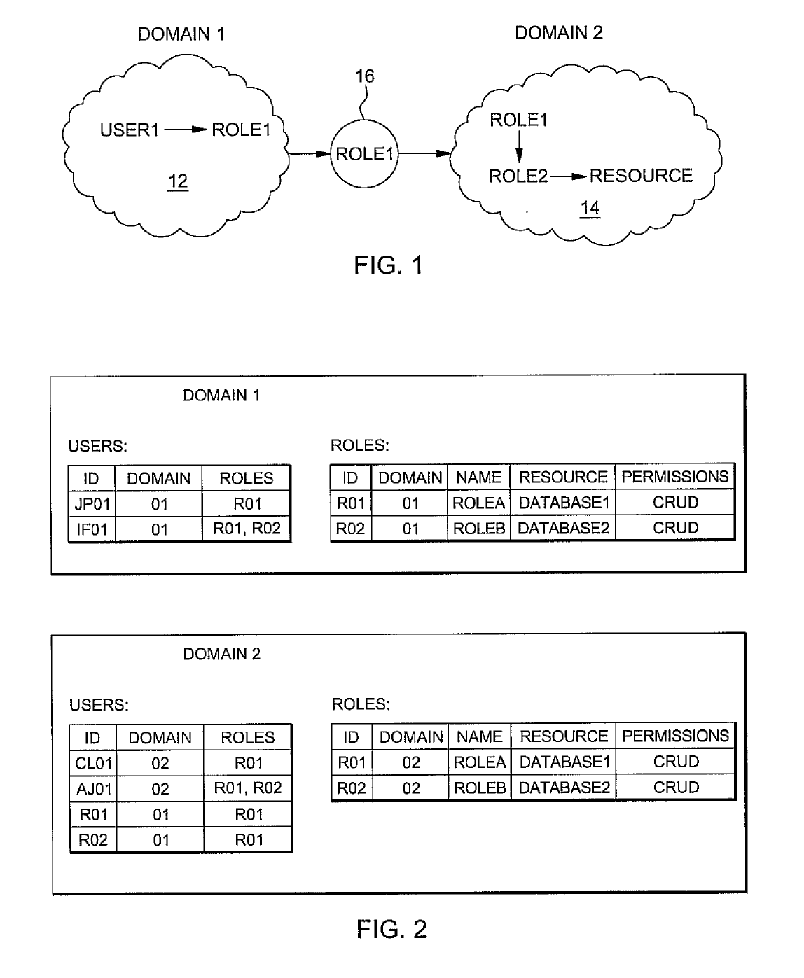

The present invention, generally, provides a method and system for authorizing a user. With reference to FIG. 1, the method comprises the steps of assigning a first role to a user in a first domain 12, assigning a second role in a second domain 14 to the first role, and assigning access to a resource in the second domain to the second role. The method comprises the further steps of receiving a request from the user for the resource; and providing access to the resource, to the user. This request may be passed via secure token 16.

The present invention may also be used for mapping from an attribute (role) in one domain to an identity (user) in another domain. This method comprises the steps of assigning a role to a user in a first domain, assigning an identity in a second domain to the role, and assigning access to a resource in the second domain to the identity. The method comprises the further steps of receiving a request from the user with the role for the resource, mapping the request to the identity in the second domain, and providing access to the resource, to the user.

The invention may be employed by users and services to manage their interaction with those services, including configuring which they trust for what types of information, in what applications, and which subsets of information they can be trusted to provide. This configuration information may be specified using any aspect of the information in question, including ancillary attributes. So, for example, configuration information may state that a certain CA is only trusted to produce certificates whose key is used for encrypting, but not for signing. Richer attribute associations can produce richer rules.

More flexible matching of attribute values (such as value comparisons or wildcarding) may further enhance the rule set. Also, attributes that are not trusted can be stripped out. For example, an attribute authority may be trusted to specify a certain group. All other attributes received from this authority are removed from or ignored in the request.

The advantage of using a rich rule set to configure which security authorities are trusted for what kinds of information enables the development and deployment of distributed collaborative applications that can be used on coopetition—both cooperative and competitive settings. Without this kind of support, a potential competitor's authority is overly trusted (exposing company intellectual property) and excessive (management must replicate the security knowledge in every domain of interest).

In the example discussed earlier—where employees from first and second companies work together on a joint proposal—that would mean an authentication authority of the first company registering each of the cooperating employees of the second company, and then putting manual guidelines in place on which applications could and should use that authentication information for access.

In the diagram of FIG. 2, user JPOS in Domain 1 is assigned to Role RO1. That gives her create, read, update and delete (CRUD) access to Database 1 in the local domain. When JPO1 requests access to resources in Domain 2, JPO1 passes it's role (RO1) and domain information to Domain 2 via a secure, trusted token 16, along with the request for information. Domain 2 sees that user RO1 from Domain 1 is assigned to local role RO1. That local role provides CRUD access to the local Database 1, so the request is fulfilled and the Domain 1 user gets what she asked for. If the request made by JPO1 was for access to local Database 2, it would have been denied because in Domain 2, user RO1 from Domain 1 is not assigned role RO2 which provides CRUD access to the local calendar. An important benefit of this approach is that Domain 2 does not have to know about every user in Domain 1; only the roles, which are defined as users in Domain's local directory.

A database may be used to make the interdomain mapping (role to user, or role to role). The association of the first role in the first domain with the second role or identity in the second domain may be established with a database schema or other metadata association technology (such as an XML schema). The schema defines the association, using the role in the first domain as an index or key into a row or record. The rest of the cells in the row are the roles or identities in the second domain that the first role maps to. These are used to determine access when a request from the firs role is received by the second domain.

In addition, the association of the first role in the first domain with the second role or identity in the second domain may be expanded in several ways. It may be a many to one mapping, where both Role X and Role Y in the first domain are required on a request to associate that request with a second role or identity in the second domain. It may be a one to many mapping, where a single role in the first domain is associated with several roles or identities in the second domain, with the ability to access any information those roles and identities can access. It may be a many to many mapping where both Role X and Role Y in the first domain are required on a request before an association is made, and that association is to several roles or identities in the second domain.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What we claim is:

1. A method of authorizing a user of a first domain with access to resources of a second domain, the method comprising the steps of:
assigning first role first and second roles to a user in a first domain;
assigning a specified role in a second domain to the first role only if the user has been assigned the first and second roles in the first domain;
assigning access to a resource in the second domain to the specified role;
receiving a request from the user for the resource; and
providing the user with access to the resource, only if the user has been assigned the first and second roles in the first domain without allowing any user who does not have both of the first and second roles, access to the resource.

2. A method according to claim 1, wherein said request includes information identifying the roles of the user in the first domain.

3. A method according to claim 2, wherein said request also includes information about the first domain.

4. A method according to claim 1, wherein the receiving step includes the step of passing a secure, trusted token to the second domain identifying the roles of the user in the first domain.

5. A method according to claim 1, wherein:
a set of users have roles in the first domain; and
some of said roles in the first domain are defined as users in the second domain.

6. A method according to claim 1, further comprising the step of providing a database that identifies, for each of a set of roles in the first domain, one or more roles in the second domain, and wherein the step of assigning a specified role in a second domain to the first role includes the steps of using said first role as an index into said database to identify said specified role from the database.

7. A method according to claim 1, wherein each of a set of roles in the first domain is mapped to one or more roles in the second domain using a procedure selected from the group comprising: mapping each of said set of roles in the first domain to a respective one role in the second domain, mapping each of said set of roles in the first domain to a plurality of roles in the second domain, and mapping a plurality of roles in the first domain to one, common role in the second domain.

8. A system for authorizing a user of a first domain with access to resources of a second domain, the system comprising:
means for assigning first and second roles to a user in a first domain;
means for assigning a specified role in a second domain to the first role only if the user has been assigned the first and second roles in the first domain;
means for assigning access to a resource in the second domain to the specified role;
means for receiving a request from the user for the resource; and
means for providing the user with access to the resource only if the user has been assigned the first and second roles in the first domain without allowing any user who does not have both of the first and second roles, access to the resource.

9. A system according to claim 8, wherein said request includes information identifying the roles of the user in the first domain.

10. A system according to claim 9, wherein said request also includes information about the first domain.

11. A system according to claim 8, further comprising:
a secure, trusted token identifying the roles of the user in the first domain; and
means for passing the token to the second domain.

12. A system according to claim 7, wherein:
a set of users have roles in the first domain; and
some of said roles in the first domain are defined as users in the second domain.

13. A system according to claim 8, further comprising a database that identifies, for each of a set of roles in the first domain, one or more roles in the second domain, and wherein the means for assigning the specified role in a second domain to the first role includes means for using said first role as an index into said database to identify said specified role from the database.

14. (canceled)

15. A program storage device readable by machine, tangibly embodying a program of instructions executable by the machine to perform method steps for authorizing a user of a first domain with access to resources of a second domain, said method steps comprising:
assigning first and second roles to a user in a first domain;
assigning a specified role in a second domain to the first role only if the user has been assigned the first and second roles in the first domain;
assigning access to a resource in the second domain to the specified role;
receiving a request from the user for the resource; and
providing the user with access to the resource only if the user has been assigned the first and second roles in the first domain without allowing any user who does not have both of the first and second roles, access to the resource.

16. A program storage device according to claim 15, wherein said request includes information identifying the roles of the user in the first domain.

17. A method according to claim 16, wherein said request also includes information about the first domain.

18. A method according to claim 15, wherein the receiving step includes the step of passing a secure, trusted token to the second domain identifying the role of the user in the first domain.

19. A method according to claim 15, wherein:
a set of users have roles in the first domain; and
some of said roles in the first domain are defined as users in the second domain.

20. A program storage device according to claim 15, wherein said method steps further comprise the step of providing a database that identifies, for each of a set of roles in the first domain, one or more roles in the second domain; and the step of assigning a specified role in a second domain to the first role includes the steps of using said first role as an index into said database to identify said specified role from the database.

21. A program storage device according to claim 15, wherein each of a set of roles in the first domain is mapped to one or more roles in the second domain using a procedure selected from the group comprising: mapping each of said set of roles in the first domain to a respective one role in the second domain, mapping each of said set of roles in the first domain to a plurality of roles in the second domain, and mapping a plurality of roles in the first domain to one, common role in the second domain.

22. A method of mapping from an attribute in one domain to an identity in another domain to provide a user of a first domain with access to resources of a second domain, the method comprising the steps of:
assigning first and second roles to a user in a first domain;
assigning an identity in a second domain to the first role only if the user has been assigned the first and second roles in the first domain;
assigning to the identity access to a resource in the second domain;
receiving a request from the user with the first role for the resource;
mapping the request to the identity in the second domain; and
providing the user with access to the resource only if the user has been assigned the first and second roles in the first domain without allowing any user who does not have both of the first and second roles, access to the resource.

23. A method according to claim 22, further comprising the step of providing a database that identifies, for each of a set of roles in the first domain, one or more roles in the second domain, and wherein the mapping step includes the steps of using said first role as an index into said database to identify said identity for the first role in the second domain.

24. A method according to claim 22, wherein each of a set of roles in the first domain is mapped to one or more identities in the second domain using a procedure selected from the group comprising: mapping each of said set of roles in the first domain to a respective one identity in the second domain, mapping each of said set of roles in the first domain to a plurality of identities in the second domain, and mapping a plurality of roles in the first domain to one, common identity in the second domain.

25. The method according to claim 1, wherein the first role has a plurality of attributes, and the second domain removes selected ones of the attributes from the first role.

26. The system according to claim 8, wherein the first role has a plurality of attributes, and the second domain removes selected ones of the attributes to provide a user of the first domain with access to resources of the second domain.
